(19) United States
(12) Patent Application Publication
(10) Pub. No.: US 2011/0251878 A1
(43) Pub. Date: Oct. 13, 2011

(54) SYSTEM FOR PROCESSING LARGE AMOUNTS OF DATA

(75) Inventors: Senthil Subramanian, Santa Clara, CA (US); Prashant Baronia, Sunnyvale, VA (US)

(73) Assignee: Yahoo! Inc., Sunnyvale, CA (US)

(21) Appl. No.: 12/759,170

(22) Filed: Apr. 13, 2010

(51) Int. Cl. G06Q 30/00; G06Q 10/00; G06F 17/30

(52) U.S. Cl. 705/14.5; 707/756; 707/692; 705/14.52; 707/E17.002

(57) ABSTRACT

A system for processing data includes a first data pipeline. The first data pipeline includes a processor to process a first set of data stored in a tangible memory. The system also includes a second data pipeline to process a second set of data. A mapping processor matches the first set of data to the second set of data to produce a third set of data.

### TECHNICAL FIELD

The present description relates generally to systems and methods for processing large amounts of data, and more particularly to processing behavioral targeting data to forecast supply inventory.

### BACKGROUND

Mining large amounts of data, such as mining terabytes worth of data to predict future advertising inventory for advertising exchanges, may present a problem for online display advertising systems. Advertising exchanges are technology platforms for buying and selling online ad impressions. Advertising exchanges can be used by both buyers, including advertisers and agencies, and sellers, including online publishers, because of efficiencies they provide.

Despite the current economic forecasts, the surge in marketing budgets being diverted into digital continues unfettered. Digital media offers marketers a rapid, highly targeted, interactive, measurable and cost effective route to target consumers, something that may become even more important in times of uncertainty. With huge volumes of webpages being created daily, bringing with it a similar surge of new inventory, online publishers may seek to maximize their yields right across their properties by monetizing both their premium and unsold inventory. At the same time, the inventory may help online advertisers' source new opportunities to target their audience.

This growth is taking place in an environment of continuing media and audience fragmentation. However, it is the increasing complexities of reaching audiences that has driven the emergence of online advertising exchanges to provide efficiencies and reduce the complexities in an incredibly dynamic environment. Hundreds of millions of websites and huge volumes of online advertising are communicated around the world every day.

### SUMMARY

A system for processing data includes a first data pipeline. The first data pipeline includes a processor to process a first set of data stored in a tangible memory. The system also includes a second data pipeline to process a second set of data. A mapping processor matches the first set of data to the second set of data to produce a third set of data.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a network environment and system for distributing advertisement impressions.

FIG. 2 is a flow/block diagram illustrating a method and system to mine large amounts of data.

FIG. 3 is a flowchart of a process for forecasting advertisement inventory.

FIG. 4 is a block diagram of exemplary data pipeline processing.

FIG. 5 is an exemplary processing system for executing the advertisement impression forecasting systems and methods.

### DETAILED DESCRIPTION

The systems and methods, generally referred to as systems, described herein relate to mining and/or processing large amounts of data for information. The system is described in terms of mining stored advertising related data to predict future advertising impression inventory, but other implementations may also be used. Currently, on the order of terabytes of raw advertising data is available, and the system may be used to target and obtain fine-grained user level behavioral information from all of the advertising data. The mined data may be in the form of twenty billion impressions per day. To support ad exchanges or other technology platforms for buying and selling online ad impressions, the system may provide a scalable solution capable of supporting different targeting attributes. Due to sheer volumes of data being mined, the system may utilize sampling schemes which are accurate representations of the data sets and at the same time retain user behavior for targeting. The system may also provide a way to retain both seasonal and day of week trends for the inventory. While longer data histories may provide for better forecasts than shorter histories, the system may provide mechanisms to depict years of history with limited storage. The system may also account for corrupt or missing data.

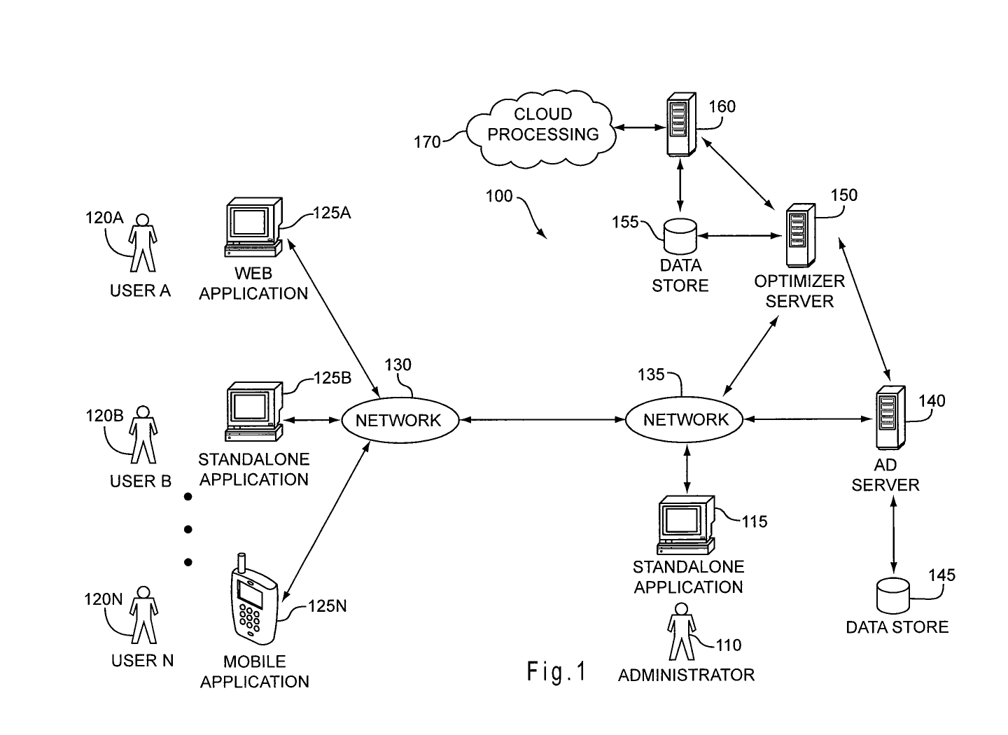

FIG. 1 provides a simplified view of a network environment 100 for serving advertisements, such as on-line advertisement impressions, using the data mining system. Not all of the depicted components may be required, however, and some implementations may include additional components not shown in the figure. Variations in the arrangement and type of the components may be made without departing from the spirit or scope of the claims as set forth herein. Additional, different or fewer components may be provided. The advertisements may be composed of words, sounds, links to web-pages, graphics, etc.

The network environment 100 may include an administrator 110 and one or more users 120A-N with access to one or more networks 130, 135, and one or more web applications, standalone applications, mobile applications 115, 125A-N, which may collectively be referred to as client applications. The network environment 100 may also include one or more advertisement servers 140 and related data stores 145, and one or more optimizer servers 150 and related data stores 155. The users 120 A-N may request pages, such as web pages, via the web application, standalone application, mobile application 125 A-N, such as web browsers. The requested page may request an advertisement impression from the advertisement server 140 to fill a space on the page. The advertiser server 140 may serve one or more advertisement impressions to the pages in accordance with delivery instructions from the optimizer server 150. Alternatively, the advertiser server 140 generates delivery instructions, and an optimizer server 150 is not used. The advertisement impressions may include online graphical advertisements, such as in a unified marketplace for graphical advertisement impressions. Some or all of the advertisement server 140, the optimizer server 150, and the one or more web applications, standalone application, mobile applications 115, 125A-N, may be in communication with each other by way of the networks 130 and 135.

The optimizer server 150 may use a machine learning algorithm. The algorithm may track which advertisements are performing well and in which markets. The optimizer server 150 may also track how advertisements are doing among various races, sexes, age groups, etc. The optimizer server 150 may also ensure that all advertisement get an opportunity for serving. Based on a success among various criteria the advertisement may be classified and grouped. If an advertisement is doing well then the advertisement may be ranked higher and if a advertisement is not doing well then the probability of that advertisement being served may decrease.

A forecasting server 160 may be connected to the data store 155 and other data stores that include advertising related information, including information about users that view the advertisements, types and dates of pages viewed, advertisements viewed, and position of advertisements on pages. The forecasting server 160 may also be connected to the optimizer server 150 and other servers for supplying information, such as information about predicted future advertising inventory. To process large amounts of data used by the forecasting server 160, the forecasting server 160 may employ an array of processors such as through cloud computing 170. More details about an operation of the forecasting server 160 are provided below.

The networks 130, 135 may include wide area networks (WAN), such as the Internet, local area networks (LAN), campus area networks, metropolitan area networks, or any other networks that may allow for data communication. The network 130 may include the Internet and may include all or part of network 135; network 135 may include all or part of network 130. The networks 130, 135 may be divided into sub-networks. The sub-networks may allow access to all of the other components connected to the networks 130, 135 in the system 100, or the sub-networks may restrict access between the components connected to the networks 130, 135. The network 135 may be regarded as a public or private network connection and may include, for example, a virtual private network or an encryption or other security mechanism employed over the public Internet, or the like.

The web applications, standalone applications and mobile applications 115, 125A-N may be connected to the network 130 in any configuration that supports data transfer. This may include a data connection to the network 130 that may be wired or wireless. Any of the web applications, standalone applications and mobile applications 115, 125A-N may individually be referred to as a client application. The web application 125A may run on any platform that supports web content, such as a web browser or a computer, a mobile phone, personal digital assistant (PDA), pager, network-enabled television, digital video recorder, such as TIVO®, automobile and/or any appliance or platform capable of data communications.

The standalone application 125B may run on a machine that includes a processor, tangible memory, a display, a user interface and a communication interface. The processor may be operatively connected to the memory, display and the interfaces and may perform tasks at the request of the standalone application 125B or the underlying operating system. The memory may be capable of storing data. The display may be operatively connected to the memory and the processor and may be capable of displaying information to the user B 125B. The user interface may be operatively connected to the memory, the processor, and the display and may be capable of interacting with a user B 120B. The communication interface may be operatively connected to the memory, and the processor, and may be capable of communicating through the networks 130, 135 with the advertisement server 140. The standalone application 125B may be programmed in any programming language that supports communication protocols. These languages may include: SUN JAVA®, C++, C#, ASP, SUN JAVASCRIPT®, asynchronous SUN JAVASCRIPT®, or ADOBE FLASH ACTIONSCRIPT®, ADOBE FLEX®, amongst others.

The mobile application 125N may run on any mobile device that may have a data connection. The data connection may be a cellular connection, a wireless data connection, an internet connection, an infra-red connection, a Bluetooth connection, or any other connection capable of transmitting data. For example, the mobile application 125N may be an application running on an APPLE IPHONE®.

The advertisement server 140 may include one or more of the following: an application server, a mobile application server, a data store, a database server, and a middleware server. The advertisement server 140 may exist on one machine or may be running in a distributed configuration on one or more machines. The advertisement server 140 may be in communication with the client applications 115, 125A-N, such as over the networks 130, 135. For example, the advertisement server 140 may provide a user interface to the users 120A-N through the client applications 125A-N, such as a user interface for inputting search requests and/or viewing web pages. Alternatively or in addition, the advertisement server 140 may provide a user interface to the administrator 110 via the client application 115, such as a user interface for managing the data source 145 and/or configuring advertisements.

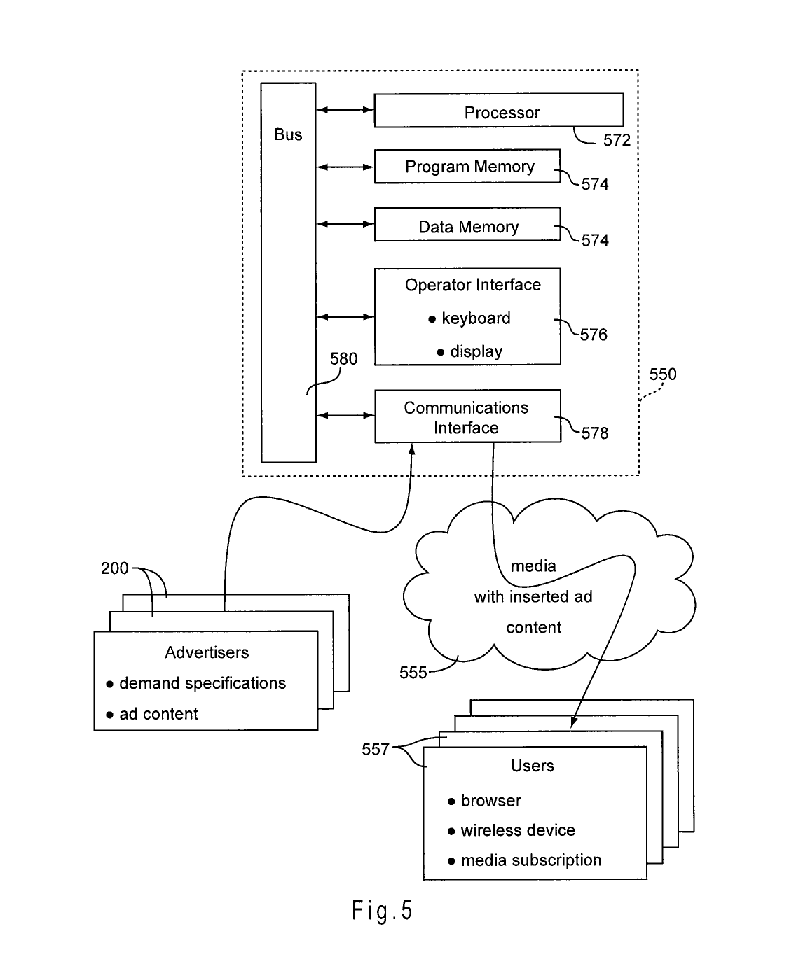

The service provider server 140, optimizer server 160 and forecasting server 160, and client applications 115, 125A-N may be one or more computing devices of various kinds, such as the computing device in FIG. 5. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 125A may employ the Hypertext Transfer Protocol (“HTTP”) to request information, such as a web page, from a web server, which may be a process executing on the advertisement server 140.

There may be several configurations of database servers, application servers, mobile application servers, and middleware applications included in the advertisement server 140. The data store 145 may be part of the advertisement server 140 and may be a database server, such as MICROSOFT SQL SERVER®, ORACLE®, IBM DB2®, SQLITE®, or any other database software, relational or otherwise. The application server may be APACHE TOMCAT®, MICROSOFT ITS®, ADOBE COLDFUSION®, or any other application server that supports communication protocols.

The networks 130, 135 may be configured to couple one computing device to another computing device to enable communication of data between the devices. The networks 130, 135 may generally be enabled to employ any form of machine-readable media for communicating information from one device to another. Each of networks 130, 135 may include one or more of a wireless network, a wired network, a local area network (LAN), a wide area network (WAN), a direct connection such as through a Universal Serial Bus (USB) port, and the like, and may include the set of interconnected networks that make up the Internet. The networks 130, 135 may include communication methods by which information may travel between computing devices.

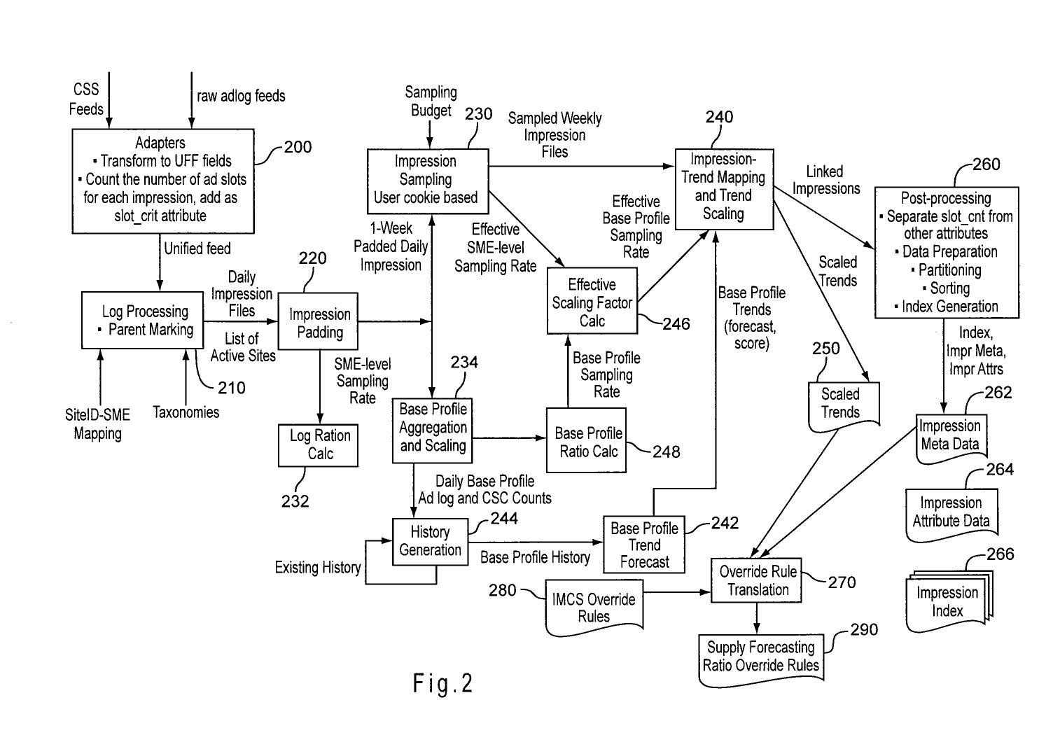

FIG. 2 is a flow/block diagram illustrating a method and system to mine large amounts of data. The mined data may be used in various ways, such as to provide forecasts about impressions in future advertising. The forecasting server 160 may employ the logic of FIG. 2, in whole or in part. Forecasts of future impressions of advertisements may be determined by combining information from multiple data pipelines at an impression trend mapping and trend scaling block 240: a first pipeline contains fine grained data, e.g., at impression sampling block 230 and a second pipeline contains coarse grained data, e.g., at base profile aggregation and scaling block 234. In other implementations information from additional data pipelines may be combined. In one example, a framework of the system operates by storing at least seven days of fine grained data and three to four years of coarse grained data to forecast advertisement inventory. Fine grained data may include more data points and/or details about the data than coarse grained data. Other time frames may be used, and in general the fine grained data may be stored over a shorter period than the coarse grained data to maximize data storage supplies. In other implementations, more or less numbers of pipelines may be used.

To feed data into the pipelines 230 and 234, at 200 adapters receive advertising and user related data, such as raw advertising related feed data and client side counting (CSC) feeds. The data includes information about the pages displayed to users and locations of the advertisements on the pages. For example, an advertisement may have been displayed on the top, right corner of a message board of Yahoo! finance. Other information includes information with regard to the users such as age, gender, a geographic location of the user, interests based on web pages visited, such as an interest in automobiles, whether the advertisement was clicked on by the user, etc. User behavior and other information may be captured in various classes of cookies, such as login cookies and browser cookies. Additional sources may be used to gather the information, such as IP addresses to determine a geographic location of the users.

Since information may be received by the adapter from a variety of sources which may have disparate formats, the adapter may transform the data into a common format, such as unified feed (UFF) format, to be used by the pipelines 230 and 234. For example, advertising related data received from China may include a different format and more or less information than the data that is received from U.S. users. The adapter may also count a number of advertisement slots for each advertisement impression, and the number of counts may be added together and saved as a slot count attribute.

At block 210, the commonly formatted data may be sent for log processing and parent marking. Web pages in a domain may be arranged in a tree structure based on a taxonomy that represents the structure of the site. Parent marking may include populating the path of the page on which impression was generated to the root defined in the taxonomy. The log processing may consume different taxonomies depending on the SME (Self Managed Entity) to which this impression belongs to. The log processing may also perform site id to SME mapping by marking the impressions of same SME with a unique identification number referred to as the SME-ID. To manage the large volumes of data and high processing needs, end to end processing may be accomplished using a distributed processing system such as cloud computing 170. In one example, the distributed processing system may be implemented with the open source Hadoop framework or other frameworks. From the log processing, daily impression files and a list of active sites on each day may be generated.

At block 220, impression padding may be performed such as to complete the data to account for enough days of data not being available or data within the time frame being corrupted. Day of the week trends may differ from each other. While padding, the day of the week trends of the data may be retained. Since the user traffic on a site may differ based on the day of week, e.g., a user may visit travel site on weekends and may not even open finance on a weekend, the day of week information for an impression may be retained, including based on the time the impression was generated. While constructing new impressions for a missing day, if possible weekend impressions are used for filling data for a weekend and weekday impression for filling impression for a weekday. In other implementations, padding of the data may not be needed or used. The padded or non-padded data may then be sent to the fine grained data pipeline at impression sampling 230 and the coarse grained data pipeline at base profile aggregation and scaling 234.

At block 230, fined grained impression sampling may be performed. The fine grained sampling may include specific user related information, such as gender, age, geographic location, preferences, etc. The pages viewed and location of the advertisements on the page may also be stored with the fine grained data. The impression sampling may be implemented for a determined short time period, such as seven days. More or less than seven days of impressions may be used depending on an implementation.

Complete user behavior may be captured for selected users rather than keeping partial information about more users. Representative sets of users may be selected and complete information maintained and forecasted based on that representative set. Users may be selected in accordance with determined criteria which matches a number of characteristics of the user for an implementation. The user cookies may be hashed by an algorithm to determine which users to collect data based on the determined criteria. Saving fine grained data for a selected number of users for a relatively short period of time may save storage space. Since only determined subsets of users are being used to collect data, the results of the impression sampling may be scaled at block 246 to account for the remainder of the users.

At blocks 232 and 234, coarse grained data may be processed. Base profile aggregation and scaling may include a log ratio calculation of the SME level sampling rate, such as after impression padding is performed. This may be done to track any SME level sampling accomplished in the upstream. The base profile aggregation 234 may be stored over longer periods of time than the impression sampling 230, such as on the order of three to four years. Other time frames of data may be used. The coarse data stored may relate to two or three key determined characteristics. For example, data related to the Yahoo! finance page may be stored, such as page type, advertisement location and the number of times the page is displayed in a day. Seasonality may be tracked for the pages, such as number of times the page is displayed during holidays, which may provide for increased shopping activities, travel seasons, week days, weekends, etc.

Using the aggregated supply data from block 234, a time series may be generated for a long period of time, e.g., 3-4 years, in the block 244. The time series may be generated in an incremental fashion with a feedback mechanism from the existing history. Using the history, forecasting algorithms may be used to determine impressions for the future at an aggregate level for a page id and an ad location on a page. Use of a longer history may produce more accurate results than if a shorter time frame was used. The forecast may include an aggregate level base profile referred to as a trend. The profile information is also maintained in the fine-grained impression data, which is travelling through the first pipeline including blocks 220, 230.

The base profile aggregated output at block 234 may also be used to calculate the base profile based scaling factor (block 248) to bring back the sampled impressions to the hundred percent level to account for all users. Block 246 may append the data of block 248 for determined period, e.g., seven days. The block 240 takes as input the seven day sampled impression data from 230, long term base profile forecast information from 242 and seven day scaling information from 246. Using this information, each impression obtained form 230 is associated with a forecast base profile from 242 and a scaling factor from 246. The weight to account for sampling of each impression may also be calculated. In one example, an impression “I” may be associated with a forecast trend T (value 1.2) and scaling factor 40. Block 240 calculates the weight of the impression “I” in this scenario as 40*1.2=48. The trend value T (in the above example 1.2) and the associated scaling factor captures the seasonality, day of week, holiday information, and other information depending on an implementation, etc.

At block 240, the impression trend mapping and trend scaling may output scaled trends to account for user sampling and linked impressions. The scaled trends may be stored in a scaled trends database 250.

The impression trend mapping may link the seasonality of the coarse grained data for the properties being sold, such as the web page name and location of an advertisement on the page, with the fine grained data related to the users, such as gender, age, geographic location, etc. To forecast a number of impressions, the impression trend mapping and trend scaling block 240 may look for an exact match between the seasonal coarse grained data and fine grained user data based on a type of user desired by the advertiser. For example, if the advertiser desires to purchase impressions of its advertisement to be viewed by males that live in Sunnyvale, Calif. with an interest in automobiles, the page identifier, such as Yahoo! Finance message board, and advertisement position data of the coarse grained data is matched to the page identifier and advertisement position data for the users whose fine grained data meets that criteria. The number of matches may be used to forecast the number of impressions that are available for sale. If exact matches do not exist for Yahoo! Finance message board or there is currently not enough data to make an accurate match, the scope may be changed from Yahoo! Finance message board to the Yahoo! Finance site and a forecast made on that basis. In general, if a matching trend is not found for the page id and advertisement position being searched, the system may move up or down the taxonomy tree that captures the site structure/organization using the parent marking done in block 210 and try to match the impression with trend line of the parent, child, etc.

The matched or linked impressions may be processed by post-processing routines at block 260. The post-processing may include separate slot counts from other attributes, data preparation to enable indexing, partitioning the dataset to more manageable sizes, sorting and impression index generation. From the post-processing, impression metadata may be stored at 262, impression attribute data may be stored at 264 and the impression index that enables real-time querying may be stored in impression index 266.

At block 270, override rule translation may be processed. The override 270 may be used to manually account for events that occur ad hoc or events that are unpredictable. For example, after a celebrity dies or an earthquake occurs viewership of the news regarding those events may increase over a determined time period. The override rule translation at block 270 may utilize data for the scaled trends at 250, impression meta data at 262, impression attribute data 264 and the impression index at 266. The override rule translation at block 270 may also obtain the override rules from the IMCS (Inventory Management Control System) where moderators enter these override rules that are stored in database 280. This may produce adjustment ratios which are saved into database 290. The adjustment ratios may then be applied, e.g., multiplied, to the normal forecast numbers generated by the forecasting server 160 to provide advertising inventory forecasting, such as to be used when serving advertisements by the ad server 140.

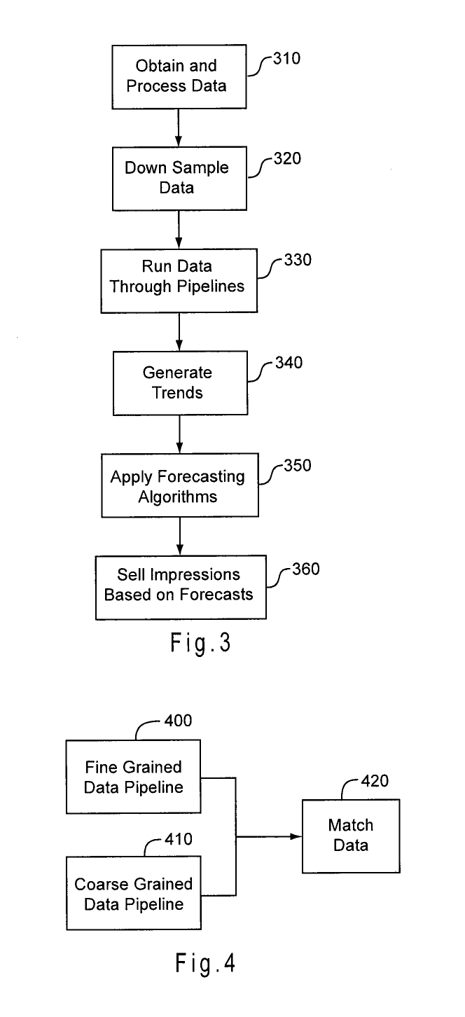

FIG. 3 is a flowchart of a process for forecasting advertisement inventory. At block 310, advertising and user related data may be obtained and processed. Data cleaning may be used to (1) drop records which are ill formed, e.g., due to bad logging or network problems (2) drop records which do not conform to certain pre defined rules (e.g., the SME id should always be numeric) or the site id should always be present in taxonomy. At block 320, after cleaning the data the data may be down-sampled. The data may be down sampled. Each impression may contain lcookie (login cookie) and bcookie (browser cookie) information. Obtaining information about a representative set of users may be achieved by performing cookie based sampling. Whenever lcookie is present the system may sample based on it, with a second preference given to bcookie. If none of the cookies are present in the impression random sampling may be accomplished. At block 330, the data may be processed through two or more data pipelines.

FIG. 4 is a block diagram of exemplary data pipeline processing. A first data pipeline 400 and second data pipeline 410 may be used to process data. The first data pipeline 400 may be used to process fine grained data, such as for impression sampling of block 230 in FIG. 2. The second data pipeline 410 may be used to process coarse grained data, such as for the base profile aggregation of block 234. The data of the first pipeline 400 may be more detailed than the data of the second pipeline 410. In addition or alternatively, the data of the first pipeline 400 may be maintained for a shorter time period than the data of the second pipeline 410, or vice versa. The data of the pipelines 400 and 410 may be processed in parallel to one another. One data pipeline 400 may include impression data which retains fine grained targeting attributes such as an age, gender, interests, geographic location, etc. of a user, and another data pipeline 410 may process trends for the aggregated data based on the base profile such as a page name and advertisement location on the page. Data from the pipelines is matched at 420, such as based on common criteria that overlap between the data in the two pipelines 400 and 410. More or less than two pipelines may be used, and the pipelines may run in series instead of parallel, or a combination thereof.

In FIG. 3, at block 340, while generating base profile targeting, user related attributes like age, gender, location, etc. may be dropped and the data is aggregated to generate trends for a set of base attributes like pageid and ad position, referred to as base profiles. The aggregated data may be small in size to provide a capability to maintain years of growth and seasonality changes in the data. For example, the summer season may have more traffic related to real estate types of sites and the Christmas season may have more traffic related to shopping types of sites. The fine grain data and the seasonal trend data may be combined to determine the forecast. Using a long history for the base profile, future inventory may be predicted.

At block 350, forecasting algorithms such as ARIMA and GSS (General Self Selectivity) may be used to forecast advertising inventor for a determined future time period, such as three years. The forecast data may be stored similar to the history data in the form of a base profile based time series. Later in the pipeline impressions may be associated with these trends to achieve a forecasting trend associated with each impression. At block 360, each impression may be scaled based on the trends it is associated with to compensate for the sampling and thus bringing the inventory to its original hundred percent level.

The system may allow for flexibility to work in an exchange kind of environment and consume large amounts of heterogeneous advertising, or other, related data. User based preferential sampling captures behavior of individuals in the representative set of the data. The system may allow for years of history data to be stored for better forecasting, while at the same time saving storage space. Each impression may be associated with a trend for growth and seasonality changes. The forecasts may be used to determine whether impressions are increasing, decreasing or staying the same for certain advertisements.

Forecasts may also be used to determine how much inventory of impressions for advertisements an advertiser provider may expect in the future. For example, if the advertiser desires to purchase one million impression, and it is forecasted that there will be ten million impressions, then the forecast may be used to determine that the one million impressions are available for purchase by the advertiser. The advertiser may also book a percentage of the forecasted available inventory of impressions. The desired percentage may affect that price such that a desired higher percentage of impressions may command a higher price. The forecaster may also be used to determine what types of users are expected, such as based on gender, age, geographic location, interests, etc.

FIG. 5 illustrates a practical embodiment as a block level diagram wherein the forecasting system is configured as a computer system 550 that is coupled for data communications, for example to provide media in the form of html web pages and graphics files over a communication path traversing the Internet 555 to various remote users 557, who may be appropriate targets for advertising content provided by advertisers. The computer system 550 can be associated with a service such as a directory service or search engine, or a retail or wholesale outlet or any of various operations whose activities include transmission of media to users 557.

The system 550 as shown can include one or more processors 572, implemented using a general or special purpose processing engine such as a microprocessor, controller or other control logic configuration. In the example shown, processor 572 is coupled via a bus 580 to program and data memory 574, an interface 576 for input/output with a local operator, including, for example, a keyboard, mouse, display, etc., and a communications interface 578. The communications interface is generally shown coupled for communications with advertisers 200 or over the Internet with remote users 557; however it is likewise possible that other specific techniques could be employed to deliver data from the advertiser to system 550, such as hand transferred data carriers, telephone discussions or even paper exchanges. The manner of transmitting media to the users 557 likewise is not limited to web page data transmission and could comprise, for example cable or other video program distribution among other possible embodiments.

The memory 574 of the computing system advantageously includes random access volatile memory and ROM, disc or flash nonvolatile memory for initialization. The program instructions are stored in and executed from the program memory to carry out the functions discussed above. The memory can include persistent data storage for accumulated data respecting advertiser and user information, for example on hard drives. Advantageously, the memory 574 of system 550 can contain locally stored versions of advertising copy that is to be inserted, especially for servicing guaranteed demand. The memory 574 also can receive, preferably store and insert at least some advertising copy from advertisers 22 who undertake to use ad impressions obtained on the ad hoc spot market.

Alternatively or in addition, at least part of the advertising copy to be inserted can be stored remotely and accessed by providing to the browser at the user system the appropriate URLs identifying advertising content to be inserted. For example, system 550 can store and submit to the user browser a network address for graphics or other content to be inserted, which address refers to a system at or associated with the advertiser 22, which system is coupled for web communications and is configured to respond to an IP request for addressed graphic or media content. That content can be obtained by bidirectional IP communications between the browser and the system where the content is stored

The persistent storage devices of memory 574 may include, for example, a media drive and a storage interface for video or other substantial storage capacity needs. The media drive can include a drive or other mechanism to support a storage media. For example, a hard disk drive, a floppy disk drive, a magnetic tape drive, an optical disk drive, a CD or DVD drive (R or RW), or other removable or fixed media drive may be employed. The storage media can include, for example, a hard disk, a floppy disk, magnetic tape, optical disk, a CD or DVD, or other fixed or removable medium that is read by and written to by the media drive.

The terms “computer program medium” and “computer useable medium” and the like are used generally to refer to media such as, for example, memory 574, various storage devices, a hard disk and hard disk drive and the like. These and other various forms of computer useable media may be involved in carrying one or more sequences of one or more instructions to processor 572 for execution. Such instructions, generally referred to as “computer program code” (which may be grouped in the form of computer programs or other groupings), when executed, enable the computing system 550 to perform features or functions of the embodiments discussed herein.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

The network could be the worldwide web and the advertising copy could comprise banner ads, graphics in fields of specific size and placement, overlaid moving pictures or animation, redirection to a different URL, etc. The same targeting abilities are also applicable to networks that are interactive to a lesser degree, such as cable television ad insertion, which might be done at a head end or at a hub, or even from a subscriber-specific set top box.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A system for processing data, comprising:
a first data pipeline including a processor to process a first set of data stored in a tangible memory;
a second data pipeline to process a second set of data; and
a mapping processor to match the first set of data to the second set of data to produce a third set of data.

2. The system of claim 1, where the first set of data comprises fine grained data including an age, gender, webpage view, location of advertisements on the webpage views, and geographic location of a user.

3. The system of claim 2, where the second set of data comprises a coarse grained data including a name of a webpage and location of an advertisement on the webpage.

4. The system of claim 3, where the first set of data and the second set of data are matched to produce the third set of data in accordance with the webpage and location of the advertisement on the webpage.

5. The system of claim 1, where the third set of data is used to forecast a number of impressions available in the future.

6. The system of claim 1, where the forecast is determined for a time of year, including a season or event.

7. The system of claim 1, where the first set of data is maintained in memory for about a week and the second set of data is maintained in memory for over two years.

8. The system of claim 1, where the first set of data and the second set of data are padded to account for missing or corrupt data.

9. A method for processing data, comprising:
receiving a first set of data and a second set of data;
storing the first set of data and the second set of data in a tangible memory;
providing a first data pipeline including a processor to process the first set of data;
providing a second data pipeline to process the second set of data; and
matching the first set of data to the second set of data with a mapping processor to produce a third set of data.

10. The method of claim 9, where the first set of data comprises fine grained data including an age, gender, webpage view, location of advertisements on the webpage views, and geographic location of a user.

11. The method of claim 10, where the second set of data comprises a coarse grained data including a name of a webpage and location of an advertisement on the webpage.

12. The method of claim 11, where matching the first set of data and the second set of data to produce the third set of data comprises matching the webpage and location of the advertisement on the webpage for the first set of data and the second set of data.

13. The method of claim 9, further comprising forecasting a number of impressions available in the future based on the third set of data.

14. The method of claim 9, where the forecast is determined for a time of year, including a season or event.

15. The method of claim 9, where the first set of data is maintained in memory for about a week and the second set of data is maintained in memory for over two years.

16. The method of claim 9, further comprising padding the first set of data and the second set of data to account for missing or corrupt data.

17. A system for forecasting impressions, comprising:
a first data pipeline including a processor to process fine grained data including an age, gender, webpage view, location of advertisements on the webpage views, and geographic location of a user stored in a tangible memory;
a second data pipeline to process a coarse grained data including a name of a webpage and location of an advertisement on the webpage; and
a mapping processor to match the fined grained data to the coarse grained data to produce a forecasting data, where the mapping processor determines a number of forecasted impressions available for sale in accordance with the forecasting data.

18. The system of claim 17, where the fined grained data and coarse grained data are matched in accordance with the webpage and location of the advertisement on the webpage.

19. The system of claim 18, where the webpage or the location of the advertisement on the webpage is changed if no exact match is found.

20. The system of claim 17, where the forecast is determined for a time of year, including a season or event.

21. The system of claim 17, where the fine grained data is maintained in memory for about a week and the coarse grained data is maintained in memory for over two years.
